(19) United States
(12) Patent Application Publication
(10) Pub. No.: US 2002/0079634 A1
(43) Pub. Date: Jun. 27, 2002

(54) Tongue lifting device for tongue blades made of stock rail profiles

(76) Inventor: Bernd Lesemann, Breckerfeld (DE)

Correspondence Address: Rocco S. Barrese, Esq., DILWORTH & BARRESE, LLP, 333 Earle Ovington Blvd., Uniondale, NY, 11553, US

(21) Appl. No.: 09/961,868

(22) Filed: Sep. 24, 2001

(30) Foreign Application Priority Data
Sep. 22, 2000 (DE) 100 47 156.3

(51) Int. Cl. B23Q 3/00

(52) U.S. Cl. 269/309

(57) ABSTRACT

A device for lifting a tongue blade (2) of points made of stock rail profiles, with a rolling device (5) includes a plurality of rollers (44, 45, 46, 47), sliding knobs, balls or the like which are orientated essentially parallel to a running rail (1), which transport said tongue blade (2) in a direction transversely to the running rail (1), and a base plate (3) which serves as rail support for said running rail (1) and which is mountable on a concrete or lumber tie, wherein said rolling device (5) can be arranged beside a longitudinal side wall of said lumber or concrete tie and is displaced downwardly such that the base of said running rail (1) and the base of said tongue blade (2) lie essentially at the same horizontal level.

### TECHNICAL FIELD

The present invention relates to a tongue lifting device for tongue blades of a railway switch made of stock rail profiles.

1. Background Art

In known tongue lifting devices it is not possible for reasons of space that tongues made of stock rail profiles are lifted and shifted. The reason for this is that when switching railway switches the tongue blades are lifted by a tongue lifting device, in particular a rolling device, which requires some space so that there is not enough space in the vertical direction for the use of tongue blades made of stock rail profiles.

A prior art tongue lifting device for lifting the tongue blades of points or a switch by means of a rolling device is published as European patent specification EP 0 495 160 B1. Reference is herewith made to this European patent specification 0 495 160 B1, stemming from the applicant, as regards the function of the rolling device.

2. Disclosure of the Invention

It is the object of the invention to provide a device for lifting in a switch a tongue blade made of stock rail profiles, which can be arranged on a lumber or concrete tie that has not to be altered from its original shape.

This object is achieved by a device of the type mentioned herein before with the features of claim 1. Advantageous embodiments are the subject of the dependent claims.

According to the invention the device for lifting a tongue blade of a switch made of stock rail profiles comprises a rolling device including a plurality of rollers, sliding knobs, balls or the like which are orientated essentially parallel to a running rail, which transport said tongue blade in a direction transversely to the running rail, and a base plate which serves as rail support for said running rail and which is mountable on a concrete or lumber tie, wherein said rolling device is arrangable beside a longitudinal side wall of said lumber or concrete tie and is displaced downwardly such that the base of said running rail and the base of said tongue blade lie essentially at the same horizontal level.

Due to the rolling device being arranged beside the lumber or concrete tie and being displaced downwardly, there is enough room in vertical direction for shifting tongue blades made of stock rail profiles. Further, a device for lifting a tongue blade according to the invention does not require the change of the original shape of a lumber or concrete tie, if a switch is to be positioned on a lumber or concrete tie having a device for lifting the tongue blade of a switch made of stock rail profiles.

It is further advantageous that said base plate comprises a sliding surface adjacent to the upper surface of said lumber or concrete tie for providing a slidable movement of said tongue plate in a transverse direction relative to the running rail.

The base plate can further comprise a mount for the rolling device on which said rolling device is mountable. Thus, the rolling device for shifting and moving the tongue blade can be replaced by another rolling device in case of a failure of the rolling device.

In a preferred embodiment, mount for the rolling device comprises support braces which are adapted to be in abutment with said lumber or concrete tie. As a result, the mount for the rolling device is able to transfer the weight of the tongue blade to the ground. Further, the support braces improve the alignment of the device for lifting a tongue blade according to the invention with the concrete or lumber tie.

Since at least one opening is formed below said rollers in the rolling device mount, water and dirt can run off through this opening preventing a locking of the rollers due to accumulated dirt or ice.

It is further advantageous that a pillow block is integrated into the base plate so that a single part in form of the base plate combines the function of the sliding plate, the tongue lifting means as well as the attachment of the running rail in the tongue lifting device.

In a preferred embodiment, said base plate is a cast part or forged part so that the tongue lifting device according to the invention combining different functions into one component can be manufactured in a cost advantageous manner.

When lining plates are arranged between said base plate and said lumber or concrete tie, the height of the entire tongue lifting device can be adjusted in a simple manner.

### BRIEF DESCRIPTION OF THE DRAWINGS

The invention is described only by way of example with reference to the following figures.

FIG. 1 shows a perspective view of the tongue lifting device according to the invention for tongues of blades made of stock rail profiles;

FIG. 2 shows a perspective view of the base plate of the tongue-lifting device of FIG. 1 according to the invention;

FIG. 3 shows a lateral view of the tongue-lifting device according to the invention with a running rail and a tongue blade in cross-section;

FIG. 4 shows a perspective view of the tongue-lifting device of FIG. 3;

FIG. 5 shows a view from below of the tongue-lifting device of FIG. 3; and

FIG. 6 shows a top view of the tongue lifting device of FIG. 3.

### DESCRIPTION OF THE EMBODIMENTS OF THE INVENTION

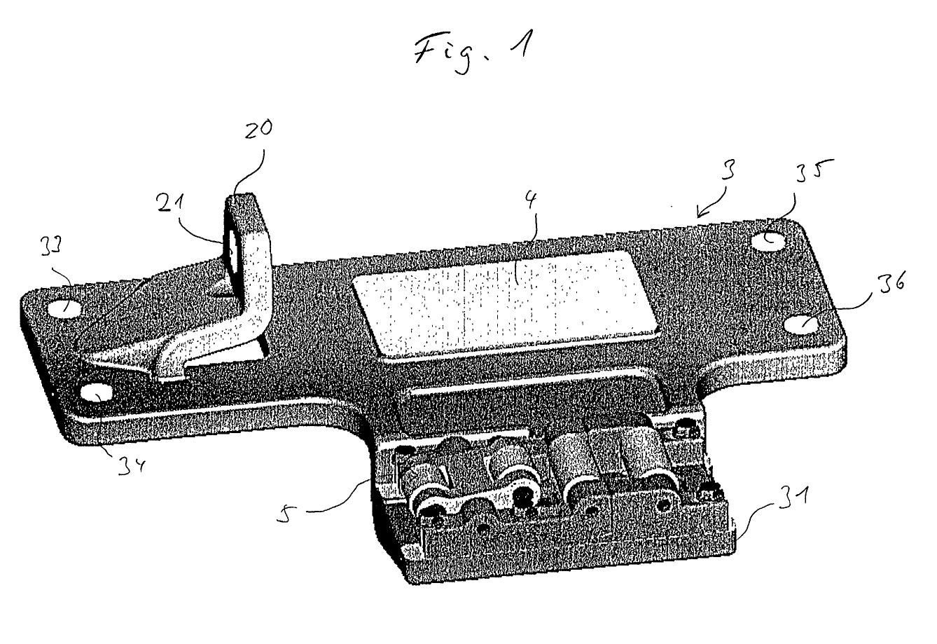

The tongue lifting device shown in FIG. 1 comprises a base plate 3 which serves as rail support for a running rail 1 not shown in FIG. 1. The base plate 3 is attached via bores 33, 34, 35 and 36 to a lumber tie or concrete tie or the like. The area of the base plate 3 extending between the bores 33, 34, 35 and 36 lies transverse to the running rail 1 on the concrete or lumber tie. In this area there is a sliding surface 4 for the sliding placement of a tongue blade 2 not shown in FIG. 1. Further a pillow block 20 is provided in this area of the base plate 3 having a bore 21, through which the pillow block 20 is screwed onto the base of the running rail 1. The pillow block 20 is preferably designed integrally with the base plate 3, which is cast or forged.

A mount 31 for the rolling device is provided on the base plate 3 along the side of the area of the base plate 3, which, in the mounted state is disposed above the lumber or concrete tie. The mount 31 for the rolling device supports preferably a rolling device 5 known from the European patent specification EP 0 495 160 B1. Thus, the rolling device 5 is disposed along side of the longitudinal side of the tie, with the mount 31 for the rolling device being displaced downwardly such that the base of the running rail 1 and the tongue base or the base of the tongue blade 2 lie essentially at the same level. Due to the lowering of the rolling device 5 by means of the mount 31 for the rolling device attached at the side of the tie, the tongue blade slides on the slide surface 4 of the base plate during the change of the switch. Consequently, the base of the tongue blade 2 and the base of the running rail 1 are essentially in the same horizontally extending plane parallel to the surface of the mount of the stock rail.

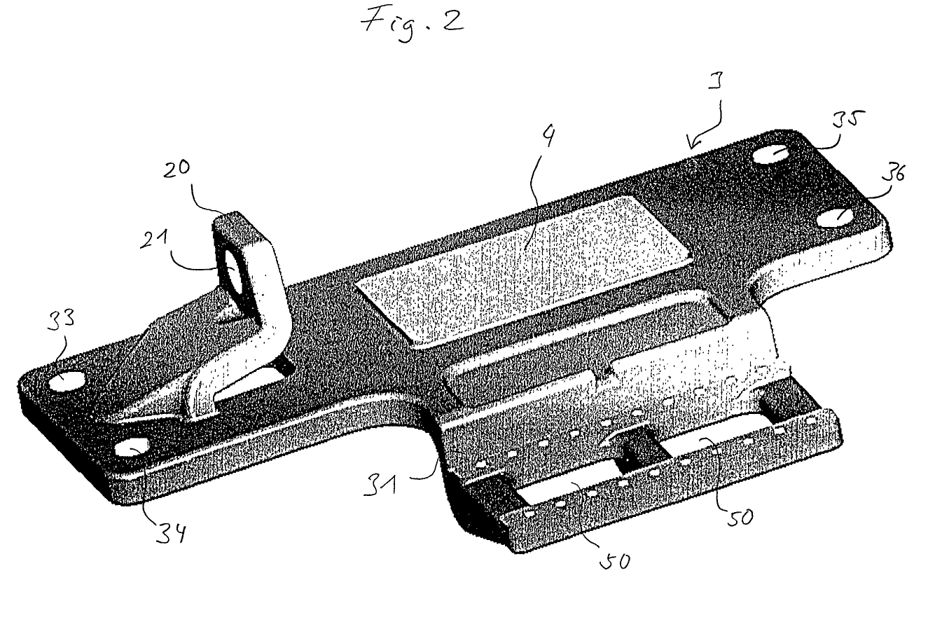

In FIG. 2 the base plate 3 is shown, wherein the mount 31 of the rolling device is depicted without the rolling device 5. The rolling device 5 can for example be screwed onto the mount for the rolling device or can be modularly attached in any other suitable manner. The base plate 3 of the tongue lifting device shown in FIG. 2 is designed integrally as a cast part, however, the base plate 3, can also be made of several parts, which for example can be screwed or welded together.

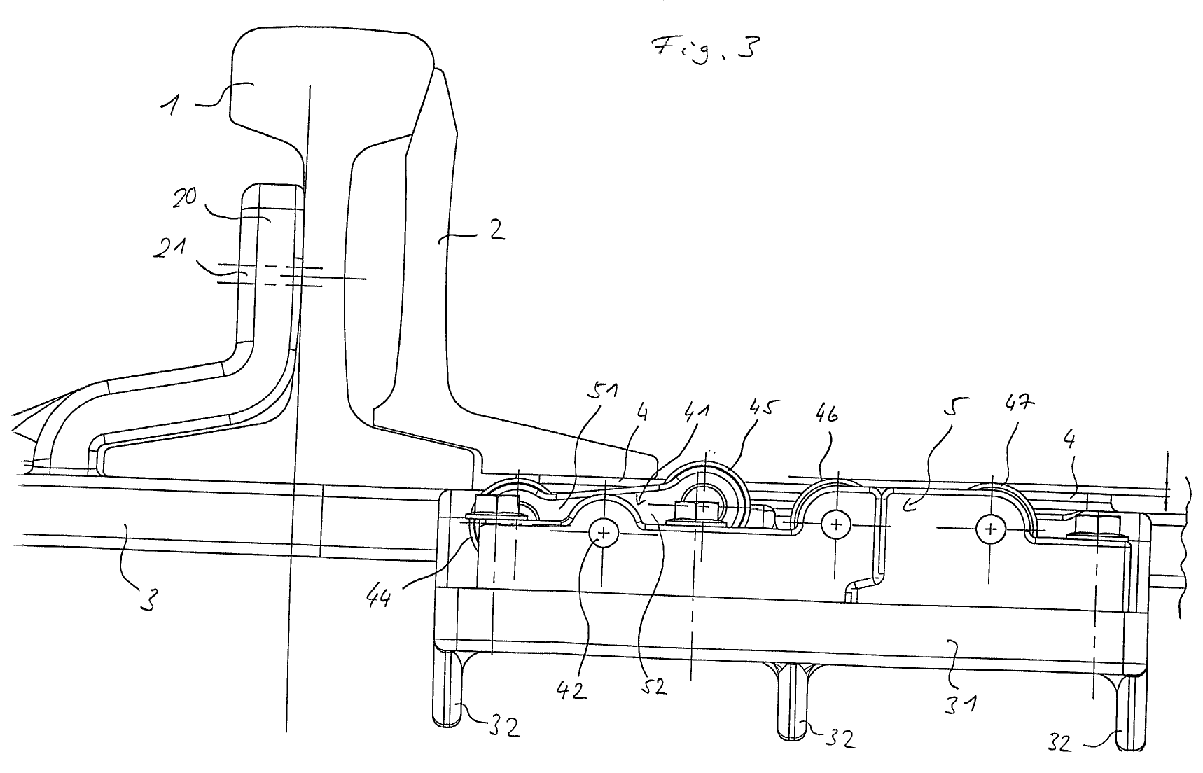

In FIGS. 3 to 6 a tongue lifting device according to the invention is shown comprising a running rail 1 and a tongue blade 2 made of stock rail profiles, with the tongue lifting device being shown without a slide chair.

In FIG. 3 the running rail 1 is shown in cross section on the tongue lifting device, which is attached via a screw fitting with a pillow block 20 to the base plate 3 of the tongue lifting device. The tongue blade 2 rests on the sliding surface 4 and is contiguous with the running rail 1. The base of the tongue blade 2 comprises thereby a recess so that the tongue blade 2 is supported on the base of the running rail 1.

The mount 31 of the rolling device is preferably integrally formed with the base plate 3 and is positioned such that the support surfaces of the rollers 44, 45, 46, 47 are disposed directly above the base of the running rail 1.

The rolling device 5 positioned along the side of the tie achieves the advantageous transportation of the tongue blade 2 when switching the railway switch and comprises a lever 41. The lever 41 has lever arms and is pivotable about an axis 42, with one roller 44, 45 being mounted to the lever arms 51, 52, respectively. The entire lever system extends along the area of the sliding surface 4. Two further rollers 46, 47 are provided in the area of the sliding surface 4. The tongue blade 2 is put into its final position by these two rollers 46, 47. Two openings 50 are formed below three of the rollers 45, 46, 47 in the mount 31 of the rolling device, through which openings water and dirt can run off.

In the position shown in FIG. 3 the switch is closed, with the lever 41 being tilted in such a way that the tongue blade 2 lies on the sliding surface 4 of the base plate 3. If the switch is now to be opened, the tongue blade 2 is moved away from the running rail 1. In the course of this movement the weight of the tongue blade 2 bearing on the lever arm 51 directed towards the running rail 1 decreases, and the proportion of the weight bearing on the second lever arm 52 of the lever 41 increases. As soon as the torques acting at the two lever arms 51, 52 are equal, the lever 41 assumes a horizontal position so that the tongue blade 2 is lifted by its own weight. In this horizontal position of the lever 41, the upper sides of the rollers 45, 46 are more or less at the same level as the upper sides of the rollers 46, 47. When the switch is shifted, the tongue blades 2 are finally moved away from the running rail 1 by the rollers 44, 45, 46, 47.

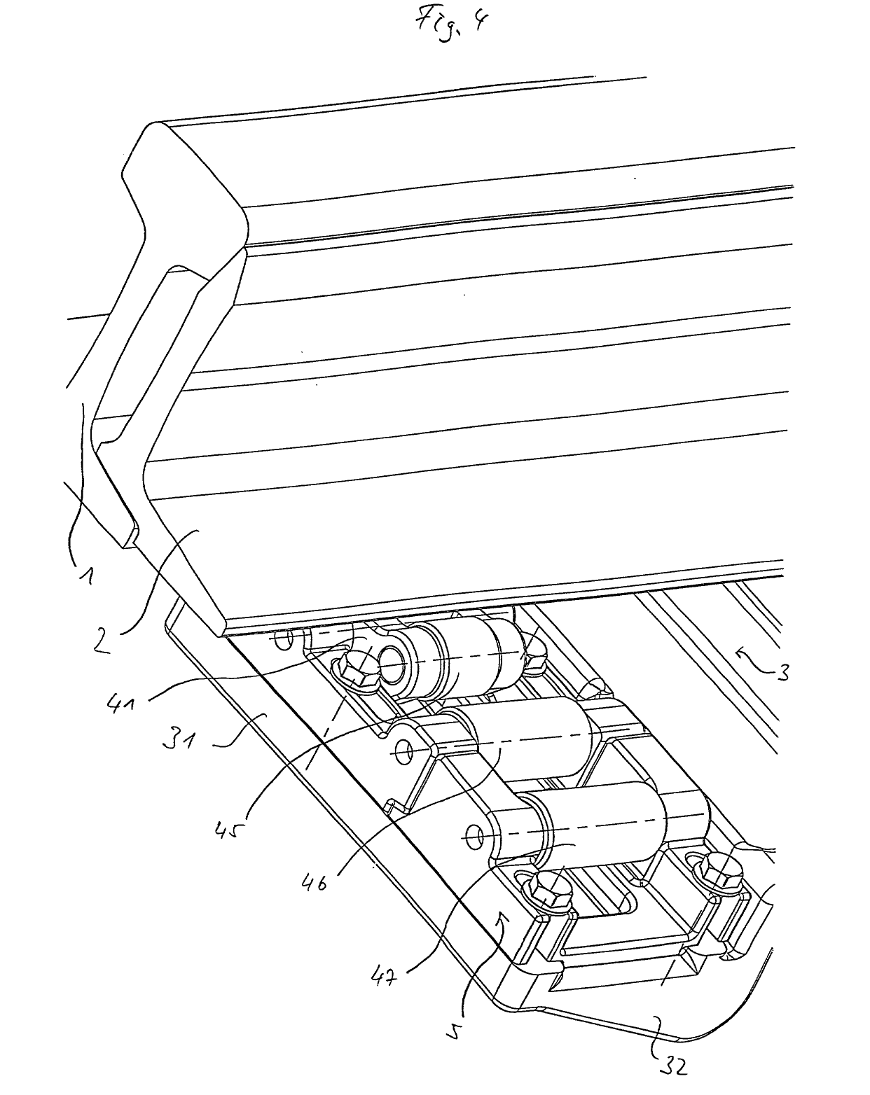

In FIG. 4 the tongue lifting device of FIG. 3 is shown from above at a slanted angle. The tongue blade 2 is engaged with the running rail 1 so that the lever 41 of the rolling device 5 is tilted. As was described above, when the switch is shifted, the tongue blade 2 is lifted by means of the lever 41 and is moved to the side on the rollers 44, 45, 46, 47.

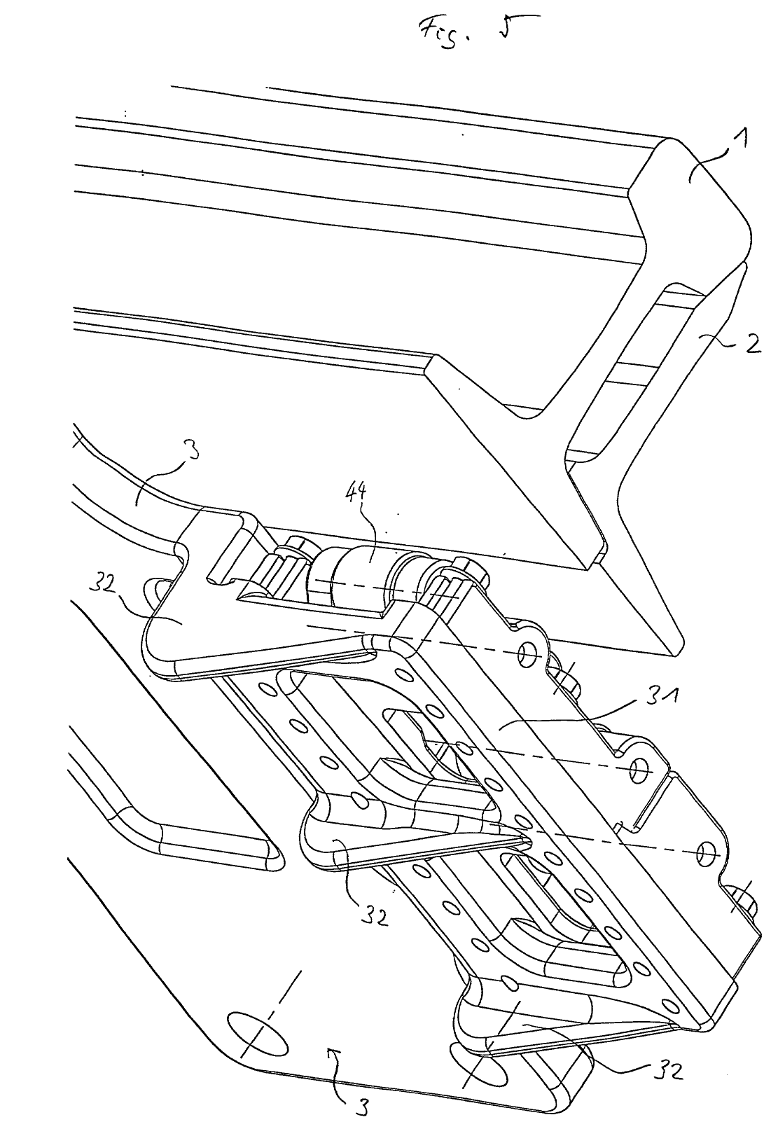

In FIG. 5 the tongue lifting device is shown from below at a slanted angle. As can be seen from FIG. 5, the mount 31 for the rolling device of the base plate 3 is displaced downwardly such that the base of the tongue blade 2 lies essentially at the same level as the base of the stock rail 1. The mount 31 for the rolling device is connected therewith via an area of the base plate 3 extending vertically. This vertically extending area serves as a lateral support surface on the concrete or lumber tie. Thus, the base plate 3 of the tongue lifting device can be aligned on the tie transversely to the stock rail direction. Three support braces 32 are arranged directly next to the area of the base plate 3 and extend in a vertical direction. The support braces 32 act as a support for the mount 31 of the rolling device downwardly and as a positioning means. The support braces 32 extending downwardly from the rolling device mount 31 act thereby also as an abutment means on a lumber or concrete tie which extends below the area of the base plate 3 with the sliding surface 4. The entire tongue lifting means can be adjusted in height by underlaying lining plates, with the lining plates being attached between the base plate 3 and the tie.

Further, in the tongue lifting device according to the invention the base plate 3 integrates the function of the sliding plate, the tongue lifting means as well as the attachment of the running rail into one component. Furthermore, the integral base plate 3 guarantees a defined space between the sliding surface 4 and the lifted tongue rail 2.

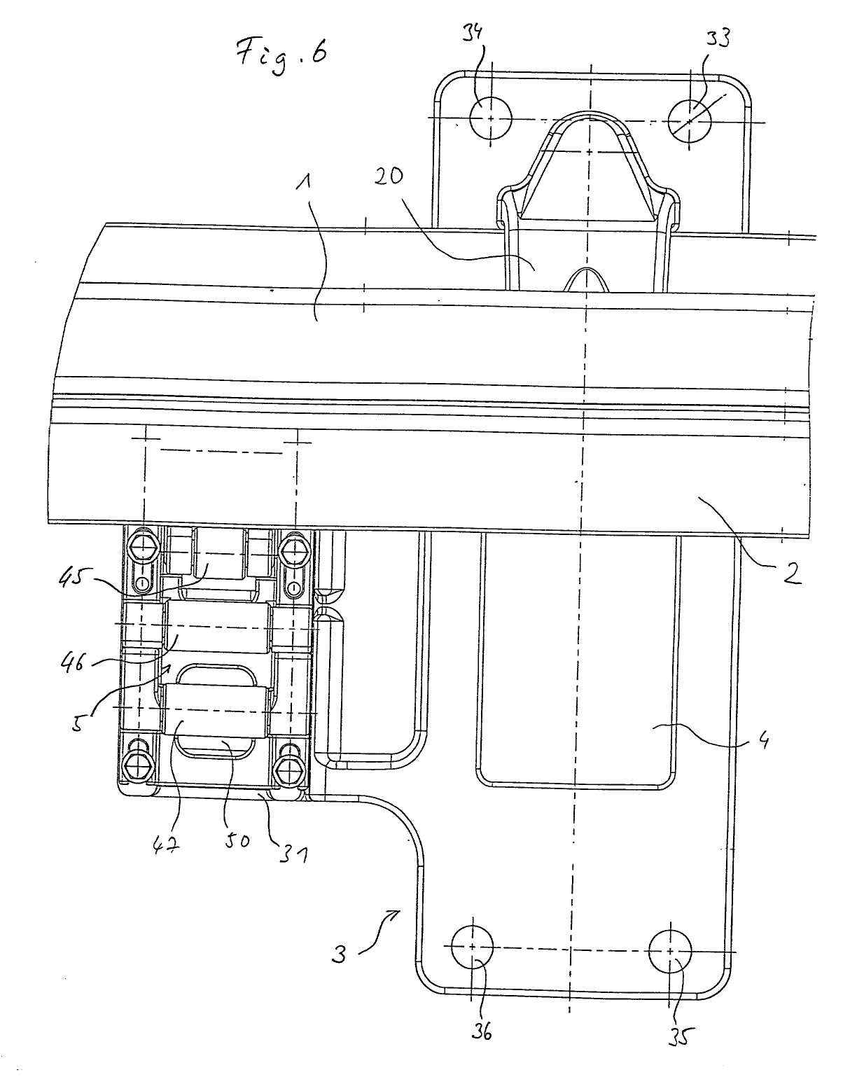

FIG. 6 shows a top view of the tongue-lifting device according to the invention having a running rail 1 and a tongue blade 2 brought into engagement therewith. The area of the sliding surface 4 of the base plate 3 extends essentially transversely to the running rail 1. The running rail 1 is connected to the base plate 3 on the side opposed to the sliding surface 4 of the base plate 3 by the pillow block 20. In the direction of the running rail 1, the mount 31 for the rolling device is such displaced from the sliding surface 4 of the base plate 3 that the mount 31 for the rolling device is disposed along the side of the tie, with the rolling device 5 for lifting the tongue blade 2 being lowered essentially to the height of the base of the running rail 1.

It is thus possible that a tongue lifting device can be used to lift a tongue blade made of stock rail profiles onto a concrete tie or a lumber tie. The tongue lifting device is characterized thereby by the base plate 3 which combines both the rolling device 5 as well as the pillow block 20 integrated into the base plate 3. Furthermore a switch tongue of stock rail profile can be used by the mount 32 for the rolling device of the base plate 3 displaced laterally and downwardly on the tie, with the rolling device 5 lying along the side of the tie and the sliding surface 4 of the tongue blade 2 on the tie.

Moreover, it is apparent to the person skilled in the art that instead of a rolling device sliding knobs, balls or the like can be provided to transport the tongue blade in transverse direction relative to the running rail.

1. Device for lifting a tongue blade (2) of a switch made of stock rail profiles, comprising a rolling device (5) including a plurality of rollers (44, 45, 46, 47), sliding knobs, balls or the like which are orientated essentially parallel to a running rail (1), and which transport said tongue blade (2) in a direction transversely to the running rail (1), and a base plate (3) which serves as a rail support for said running rail (1) and which is mountable on a concrete or lumber tie,
wherein said rolling device (5) is arranged beside a longitudinal side wall of said lumber or concrete tie and is displaced downwardly such that the base of said running rail (1) and the base of said tongue blade (2) lie essentially at the same horizontal level.

2. Device according to claim 1, characterized in that a pillow block (20) is integrated into said base plate (3).

3. Device according to any of claims 1 or 2, characterized in that said base plate (3) is a cast part or forged part.

4. Device according to claim 1, characterized in that lining plates are arranged between said base plate (3) and said lumber or concrete tie.

5. Device according to claim 1, characterized in that said base plate (3) comprises a sliding surface (4) adjacent to the upper surface of said lumber or concrete tie.

6. Device according to claim 1 or 2, characterized in that said base plate (3) comprises a mount (31) for a rolling device on which said rolling device (5) is mountable.

7. Device according to claim 6, characterized in that said mount (31) for a rolling device comprises support braces (32) which are adapted to be in abutment with said lumber or concrete tie.

8. Device according to claim 6, characterized in that at least one opening is formed below said rollers (44, 45, 46, 47) in the mount (31) for the rolling device.
